(19) United States
(12) Patent Application Publication
(10) Pub. No.: US 2008/0118758 A1
(43) Pub. Date: May 22, 2008

(54) METAL COATED WITH CERAMIC AND METHOD OF MANUFACTURING THE SAME

(75) Inventors: Joung Il Kim, Gyeonggi-do (KR); Chang Hyun Woo, Cheongju (KR)

Correspondence Address: LEYDIG VOIT & MAYER, LTD, 700 THIRTEENTH ST. NW, SUITE 300, WASHINGTON, DC, 20005-3960, US

(73) Assignee: TOKAI CARBON KOREA CO., LTD., Anseong-si (KR)

(21) Appl. No.: 11/927,763

(22) Filed: Oct. 30, 2007

(30) Foreign Application Priority Data
Nov. 17, 2006 (KR) 2006-0114010

(51) Int. Cl. B32B 15/04; B05D 3/02; B32B 9/04; B05D 3/06

(52) U.S. Cl. 428/450; 427/397.7; 427/551; 427/553

(57) ABSTRACT

A metal coated with a ceramic material and a method of manufacturing the same are provided. The method includes a) preparing a coating solution by dissolving a SiC precursor in a solvent; b) coating a metal material with the coating solution using a non-thermal coating technique; c) forming a SiC precursor coating layer on the metal material by drying the metal material coated with the coating solution in an oxygen-free atmosphere; d) partially removing a polymer by preprocessing the SiC precursor coating layer; and e) converting the SiC precursor coating layer into a SiC coating layer using a thermal treatment process. In this method, the SiC precursor is coated on the metal material and converted into the SiC coating layer, so that a pure SiC coating layer can be formed without causing cracking or delaminating. Thus, the metal material can have higher resistance to oxidation, chemicals, and heat. Also, by preprocessing the SiC precursor coating layer using electronic beams or ultraviolet beams, time taken to convert the SiC precursor coating layer into the SiC coating layer can be reduced, improving productivity.

### BACKGROUND OF THE INVENTION

1. Field of the Invention

The present invention relates to a metal coated with a ceramic material and a method of manufacturing the same, and more particularly, to a metal coated with a ceramic material and a method of manufacturing the same in which the surface of the metal can be coated with a single ceramic material and delamination of the ceramic material does not occur.

2. Description of the Related Art

It is generally known that SiC is a material that resists chemicals, oxidation, heat, and abrasion. Conventionally, some attempts have been made to improve resistance of a metal to chemicals, oxidation, heat, and abrasion by coating the metal with SiC.

However, since there is no way to coat a metal with pure SiC, a mixture containing SiC is coated on the metal. Also, a chemical vapor deposition (CVD) technique is conventionally used to coat a metal with SiC, so a metal having a low melting point cannot be coated with SiC.

Specifically, while SiC is deposited on a metal having a low melting point using a CVD technique at a temperature of about 1000° C. or higher, the metal melts due to the heat.

Furthermore, even if SiC is deposited using a CVD technique on a metal having a high melting point, a coating layer may be cracked or delaminated due to a difference in a coefficient of thermal expansion between the coating layer and the metal.

### SUMMARY OF THE INVENTION

The present invention provides a metal coated with a ceramic material and a method of manufacturing the same in which pure SiC can be coated on any metal irrespective of a melting point, delamination of a SiC coating layer due to a difference in coefficient of thermal expansion between the coating layer and the metal can be prevented, and a time taken to coat the metal with SiC can be reduced.

According to an aspect of the present invention, there is provided a method of manufacturing a metal coated with a ceramic material. The method includes the steps of: a) preparing a coating solution by dissolving a SiC precursor in a solvent; b) coating a metal material with the coating solution using a non-thermal coating technique; c) forming a SiC precursor coating layer on the metal material by drying the metal material coated with the coating solution in an oxygen-free atmosphere; d) partially removing a polymer by preprocessing the SiC precursor coating layer; and e) converting the SiC precursor coating layer into a SiC coating layer using a thermal treatment process.

According to another aspect of the present invention, there is provided a metal coated with a ceramic material, which is manufactured by a method including the steps of: a) preparing a coating solution by dissolving a SiC precursor in a solvent; b) coating a metal material with the coating solution using a non-thermal coating technique; c) forming a SiC precursor coating layer on the metal material by drying the metal material coated with the coating solution in an oxygen-free atmosphere; d) partially removing a polymer by preprocessing the SiC precursor coating layer; and e) converting the SiC precursor coating layer into a SiC coating layer using a thermal treatment process.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of manufacturing a metal coated with a ceramic material according to an exemplary embodiment of the present invention; and

FIG. 2 is a flowchart illustrating a method of manufacturing a metal coated with a ceramic material according to another exemplary embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in different forms and should not be construed as limited to the embodiments set forth herein.

### Embodiment 1

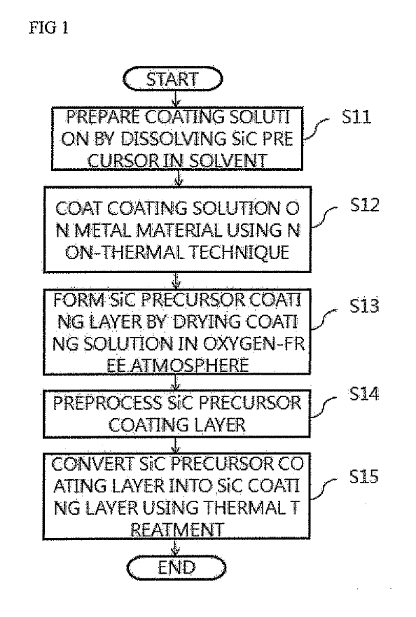

FIG. 1 is a flowchart illustrating a method of manufacturing a metal coated with a ceramic material according to an exemplary embodiment of the present invention.

Referring to FIG. 1, a method of manufacturing a metal coated with a ceramic material includes: preparing a coating solution by dissolving a SiC precursor in a solvent (step S11); coating the coating solution on a metal material (step S12); coating the metal material with the SiC precursor by drying the coating solution in an atmosphere of an inert gas to form a SiC precursor coating layer on the metal material (step S13); partially sublimating a polymer and reinforcing link between Si and C by irradiating the SiC precursor coating layer with electronic beams (e-beams) or ultraviolet beams (UV beams) (step S14); and converting the SiC precursor coating layer coated on the metal material into a SiC coating layer using a thermal treatment (step S15).

Hereinafter, the above-described method of manufacturing the metal coated with the ceramic material according to one exemplary embodiment of the present invention will be described in more detail.

In step S11, a SiC precursor is dissolved in a solvent to obtain a coating solution.

In this case, polycarbonsilane (PCS) powder may be used as the SiC precursor, and the solvent for dissolving the PCS powder may be hexane, xylan, toluene, or tetrahydrofuron.

The viscosity of the coating solution may be controlled by adjusting the amount of the PCS powder that is dissolved in the solvent. The viscosity of the coating solution determines the thickness of a PCS coating layer and is related to the thickness of a final SiC coating layer into which the PCS coating layer is converted.

That is, as the viscosity of the coating solution increases, the thickness of the SiC coating layer may increase. In this case, the viscosity of the coating solution may range from 1 to 400 cP.

In step S12, a metal material on which a coating layer will be formed is coated with the coating solution that is obtained by dissolving the PCS powder in the solvent.

In this case, the coating solution is coated using non-thermal techniques, such as a dipping technique, a spin coating technique, a spray coating technique, or a brush technique. In the dipping technique, the metal material is dipped in the coating solution. In the spin coating technique, while the metal material is rotating, the coating solution is dropped on the metal material so that the coating solution can uniformly spread by centrifugal force. In the spray coating technique, the coating solution is sprayed on the metal material using a spray unit. Also, the coating solution may be coated on the metal material using a brush.

The above-described coating techniques are only examples of non-thermal techniques that are not performed at high temperatures, and any other non-thermal techniques may be used.

Unlike in a conventional method in which a metal material is directly coated with SiC using a high-temperature CVD process, according to the present invention a SiC precursor, such as PCS, is coated at a normal temperature so that a metal material can be coated with SiC irrespective of the melting point of the metal material.

In step S13, the coating solution coated on the metal material is dried.

In this case, the coating solution may be dried in an atmosphere of an inert gas or in a vacuum atmosphere.

During the drying process, when oxygen is contained in the coating solution, high-temperature characteristics of a SiC coating layer may be degraded.

After the solvent is dried by the drying process, a PCS coating layer is coated on the metal material.

In step S14, the PCS coating layer is preprocessed to sublimate a polymer contained in the PCS coating layer. Thus, the polymer of the PCS coating layer is partially sublimated to leave SiC, and Si and C are cross-linked to each other. As a result, the SiC coating layer can be stronger.

The preprocessing process may be performed by irradiating e-beams or UV beams ranging from 5 to 20 MGy.

In addition, the PCS coating layer may be preprocessed by performing an oxidation process at a temperature of about 200 to 400° C. In this case, however, oxygen may be contained in SiC, thereby degrading high-temperature characteristics of the PCS coating layer.

In step S15, the preprocessed PCS coating layer may be thermally treated to completely remove polymer components, so that the PCS coating layer is converted into a SiC coating layer.

In this case, a process temperature may be raised at a rate of about 10 to 500° C./hour to a temperature of 700 to 1300° C.

Even if a thermal treatment is performed by raising a temperature at a high rate, foam is not formed on the SiC coating layer while the PCS coating layer preprocessed by e-beams or UV beams is converted into the SiC coating layer.

In this case, a SiC coating layer with a desired crystal structure can be obtained by controlling the final temperature at which the thermal treatment is performed. That is, the SiC coating layer may become crystalline by thermally treating the PCS coating layer in the range of about 1000 to 1300° C., and may become amorphous by thermally treating the PCS coating layer in the range of 700 to 1000° C.

According to the present invention as described above, a time taken to convert the SiC precursor coating layer into the SiC coating layer can be reduced using the preprocessing process, and the SiC coating layer can be prevented from being cracked or delaminated while the SiC precursor coating layer is converted into the SiC coating layer.

### Embodiment 2

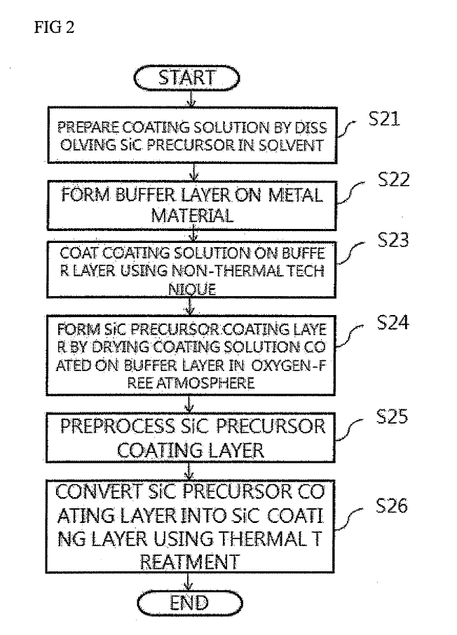

FIG. 2 is a flowchart illustrating a method of manufacturing a metal coated with a ceramic material according to another exemplary embodiment of the present invention.

Referring to FIG. 2, a method of manufacturing a metal coated with a ceramic material includes: preparing a coating solution by dissolving a SiC precursor in a solvent (step S21); forming a buffer layer on a metal material (step S22); coating the buffer layer formed on the metal material with the coating solution (step S23); coating the SiC precursor on the metal material by drying the coating solution coated on the buffer layer in an atmosphere of an inert gas to form a SiC precursor coating layer on the metal material (step S24); partially sublimating a polymer and reinforcing link between Si and C by irradiating the SiC precursor coating layer with e-beams or UV beams (step S25); and converting the SiC precursor coating layer formed on the metal material into a SiC coating layer using a thermal treatment (step S26).

Hereinafter, the above-described method of manufacturing the metal coated with the ceramic material according to another exemplary embodiment of the present invention will be described in more detail.

In step S21, PCS, which is a SiC precursor, is dissolved in a solvent to obtain a coating solution. In this case, the solvent may be hexane, xylan, toluene, or tetrahydrofuron.

However, the present invention is not limited to the above-described solvents, and any other solvent may be used if it can be removed during a drying process and chemically affects neither a metal material nor PCS.

The viscosity of the coating solution may be controlled by adjusting the amount of the PCS powder that is dissolved in the solvent. As the viscosity of the coating solution increases, the thickness of the SiC coating layer may increase. In this case, the viscosity of the coating solution may range from 1 to 400 cP.

In step S22, in addition to the preparation of the coating solution, a buffer layer is formed on the metal material.

The buffer layer may be a material layer having a coefficient of thermal expansion that is between the coefficients of thermal expansion of the metal material and the SiC. For example, the buffer layer may be an alumina layer.

By adopting the alumina buffer layer, a crack in a SiC coating layer or delamination of the SiC coating layer due to a difference in a coefficient of thermal expansion between the SiC coating layer and the metal material can be prevented from occurring during a final thermal treatment.

In step S23, the alumina buffer layer formed on the metal material on which a coating layer will be formed is coated with the coating solution that is obtained by dissolving the PCS powder in the solvent.

In this case, the coating solution is coated using any non-thermal technique, such as a dipping technique, a spin coating technique, or a spray coating technique.

In step S24, the coating solution coated on the alumina buffer layer is dried.

In this case, the coating solution may be dried in an atmosphere of an inert gas or in a vacuum atmosphere. During the drying process, when oxygen is contained in the coating solution, high-temperature characteristics of the SiC coating layer may be degraded.

After the solvent is dried, a PCS coating layer is coated on the alumina buffer layer formed on the metal material.

In step S25, the PCS coating layer is preprocessed to sublimate a polymer contained in the PCS coating layer. Thus, the polymer of the PCS coating layer is partially sublimated to leave SiC, and Si and C cross-linked to each other. As a result, the SiC coating layer can be stronger.

The preprocessing process may be performed by irradiating e-beams or UV beams ranging from 5 to 20 MGy.

In step S26, the PCS coating layer may be thermally treated to evaporate polymer components, so that the PCS coating layer is converted into a SiC coating layer.

In this case, a process temperature may be raised at a low rate of about 5 to 30° C./hour not to form foam on the SiC coating layer. Also, an amorphous or crystalline SiC coating layer can be obtained by controlling the final temperature at which the thermal treatment is performed.

That is, the SiC coating layer may become crystalline by thermally treating the PCS coating layer at a temperature above 1000° C., and may become amorphous by treating the PCS coating layer at a temperature below 1000° C.

During the final thermal treatment, the alumina buffer layer prevents a crack in the SiC coating layer or delamination of the SiC coating layer from occurring due to a difference in a coefficient of thermal expansion between the metal material and the SiC coating layer.

In the above-described process, the metal material on which the pure SiC coating layer is coated can exhibit its proper characteristics and excellent resistance to chemicals, oxidation, and heat due to the SiC coating layer.

According to the exemplary embodiments of the present invention as described above, a SiC precursor is coated on the metal material and converted into a SiC coating layer, so that a pure SiC coating layer can be formed without causing it to be cracked or delaminated. As a result, the metal material can highly resist oxidation, chemicals, and heat.

Also, by preprocessing the SiC precursor coating layer using UV beams or e-beams, a time taken to convert the SiC precursor coating layer into a SiC coating layer can be reduced, thereby improving productivity.

Furthermore, a metal coated with a ceramic material according to the present invention can exhibit its proper characteristics and can have higher resistance to oxidation, chemicals, and heat. Therefore, the metal coated with the ceramic material can be applied in more various fields.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of manufacturing a metal coated with a ceramic material, the method comprising:
a) preparing a coating solution by dissolving a SiC precursor in a solvent;
b) coating a metal material with the coating solution using a non-thermal coating technique;
c) forming a SiC precursor coating layer on the metal material by drying the metal material coated with the coating solution in an oxygen-free ambient;
d) partially removing a polymer by preprocessing the SiC precursor coating layer; and
e) converting the SiC precursor coating layer into a SiC coating layer using a thermal treatment process.

2. The method according to claim 1, wherein, in preparing the coating solution, the SiC precursor is polycarbosilane.

3. The method according to claim 1, further comprising forming a buffer layer having a coefficient of thermal expansion that is between coefficients of thermal expansion of the metal material and of the SiC on the metal material.

4. The method according to claim 3, wherein the buffer layer is an alumina layer.

5. The method according to claim 1, wherein the preprocessing includes irradiating the SiC precursor coating layer with electronic beams or UV beams.

6. The method according to claim 5, including irradiating the electronic beams in a range of 5 to 20 MGy.

7. The method according to claim 5, wherein, in preparing the coating solution, the solvent is selected from the group consisting of hexane, xylan, toluene, and tetrahydrofuron.

8. The method according to claim 5, wherein, in coating the metal material, the coating technique is selected from the group consisting of dipping spin coating, and spray coating.

9. The method according to claim 5, wherein step partially removing a polymer comprises raising a process temperature at a rate of about 5 to 30° C./hour to a final temperature of 1000±300° C.

10. The method according to claim 9, including controlling crystal structure of the SiC coating layer by controlling the final temperature.

11. A metal coated with a ceramic material manufactured by the method according to claim 5.

12. The method according to claim 2, wherein the preprocessing includes irradiating the SiC precursor coating layer with electronic beams or UV beams.

13. The method according to claim 3, wherein the preprocessing includes irradiating the SiC precursor coating layer with electronic beams or UV beams.
